(19) United States
(12) Patent Application Publication
(10) Pub. No.: US 2026/0175516 A1
(43) Pub. Date: Jun. 25, 2026

(54) HOT BED AND 3D PRINTER

(71) Applicant: Shenzhen SparkX 3D Technology Co., Ltd., Shenzhen (CN)

(72) Inventors: Yi ZHANG, Shenzhen (CN); Guoliang JI, Shenzhen (CN); Wentao LI, Shenzhen (CN); Jingke TANG, Shenzhen (CN)

(73) Assignee: Shenzhen SparkX 3D Technology Co., Ltd., Shenzhen (CN)

(21) Appl. No.: 19/344,635

(22) Filed: Sep. 30, 2025

(30) Foreign Application Priority Data
Dec. 25, 2024 (CN) 202423254329.9

(51) Int. Cl. B29C 64/245; B29C 64/295; B33Y 30/00

(52) U.S. Cl. CPC B29C 64/245; B29C 64/295; B33Y 30/00

(57) ABSTRACT

A hot bed includes a printing platform, a support frame, and a locking assembly. The printing platform is provided with a printing surface for supporting a printed object. The support frame is provided at a side of the printing platform opposite the printing surface. The support frame and the printing platform are spaced apart along a first direction and elastically connected by an elastic member. The first direction is perpendicular to the printing surface. The locking assembly is provided at the printing platform and has a friction surface that abuts the support frame. The friction surface is parallel to the first direction. A friction force parallel to the first direction is generated between the friction surface and the support frame, and is configured to restrict the relative movement of the printing platform and the support frame in the first direction.

### CROSS-REFERENCE TO RELATED APPLICATIONS

The present application claims priority to Chinese Patent Application No. 202423254329.9, filed on Dec. 25, 2024, the entire contents of which are incorporated herein by reference.

### TECHNICAL FIELD

The present application relates to the technical field of three dimensional (3D) printing, in particular to a hot bed and a 3D printer.

### BACKGROUND

3D printer is a type of rapid prototyping equipment. During printing, a feed mechanism feeds hot-melt filament material into the print head. The hot-melt filament is heated to a molten state within the print head and then moves along the printer's print path of the 3D printer. Simultaneously, the molten material is extruded onto the printing platform, creating a three dimensional object in layers.

However, the vertical displacement between the printing platform and the print head may not be within the preset range. Therefore, the printing platform needs to be leveled before printing to ensure that the print head can move relative to the printing platform along the printing path and improve the printing accuracy of the 3D printer. Currently, the printing platform and support frame are usually fixed vertically relative to each other using screws or bolts. During leveling, the height of the printing surface is adjusted by repeatedly turning the screws or bolts, which is very inconvenient.

### SUMMARY

The present application is to provide a hot bed and a 3D printer, aiming to simplify the connection structure of the hot bed and improve the leveling efficiency of the hot bed.

To achieve the above objectives, the present application provides a hot bed, which includes:
a printing platform provided with a printing surface for supporting a printed object;
a support frame provided at a side of the printing platform opposite the printing surface, wherein the support frame is spaced apart from the printing platform along a first direction and elastically connected to the printing platform by an elastic member, and the first direction is perpendicular to the printing surface; and
a locking assembly provided at the printing platform, wherein the locking assembly is provided with a friction surface abutting the support frame, and the friction surface is parallel to the first direction; and there is a friction force parallel to the first direction between the friction surface and the support frame, and the friction force is configured to restrict relative movement between the printing platform and the support frame in the first direction.

In an embodiment, the locking assembly includes a connecting member and a fastening member, and the connecting member is provided at the printing platform; and the connecting member is provided with a first surface abutting the support frame, the first surface is the friction surface, and the fastening member is configured to adjust a relative position between the first surface and the support frame in the first direction.

In an embodiment, the connecting member is provided with a connecting hole, and the fastening member includes a connecting portion and an abutting portion; the abutting portion is connected to one end of the connecting portion, the support frame is provided with a sliding hole, and another end of the connecting portion is passed through the sliding hole and is connected to the connecting hole; and the abutting portion is provided with a second surface abutting the support frame, and the second surface is also the friction surface.

In an embodiment, the connecting member includes a first part and a second part connected at an angle, the first part is connected to a surface of the printing platform opposite the printing surface, and the second part is parallel to the first direction and is provided with the first surface and the connecting hole.

In an embodiment, the first part is provided with a limiting slot, the support frame is provided with a limiting protrusion, one end of the elastic member is limited within the limiting slot, and another end of the elastic member is sleeved on the limiting protrusion.

In an embodiment, the sliding hole is configured to extend along the first direction, a diameter of the connecting portion is consistent with a width of the sliding hole, and a direction of the width of the sliding hole is perpendicular to the first direction.

In an embodiment, a diameter of the connecting portion is consistent with an aperture of the connecting hole.

In an embodiment, the locking assembly includes a plurality of locking assemblies, the elastic member includes a plurality of elastic members, each elastic member is provided adjacent to one locking assembly, and an elastic force direction of each elastic member is parallel to the first direction.

In an embodiment, a projection of the printing platform perpendicular to the first direction is quadrilateral and has four corners, the locking assembly includes four locking assemblies, and each locking assembly is provided corresponding to one corner.

In an embodiment, the printing platform is provided with a fixed position and at least two mounting positions, the printing platform is rotatably connected to the support frame at the fixed position, and the printing platform is provided with one locking assembly at each mounting position.

The present application further provides a 3D printer, which includes a print head mechanism and the hot bed as described above. The print head mechanism is adapted to press the printing platform to level the printing surface.

In the technical solution of the present application, a printing platform and a support frame are spaced apart along a first direction. The printing surface is configured to support the printed object, and the support frame is configured to support the printing platform and is installed on the side of the printing platform opposite the printing surface. The printing platform and the support frame are spaced apart along the first direction and elastically connected by an elastic member, so that the support frame and the printing platform have relative freedom of movement in the first direction. Leveling of the printing surface can be achieved by changing the relative distance between the printing platform and the support frame at various positions in the first direction. After leveling is completed, a locking assembly can restrict the relative movement of the printing surface and the support frame through friction force between the friction surface and the support frame to prevent the printing platform and the support frame from further relative movement. During leveling, a point on the printing surface is selected as a reference point, the distance between the nozzle and the reference point in the first direction is determined, and then at least two other points on the printing surface are pressed down in sequence until they are flush with the reference point, so that the distance between the nozzle and the two points in the first direction is consistent with the distance between the nozzle and the reference point in the first direction, thereby completing the leveling of the printing surface. The reference point and the at least two pressing points are not collinear. In this embodiment, the printing platform and the support frame are fixed by a locking assembly to simplify the connection structure of the printing platform and the support frame. When leveling, the printing surface can be directly pressed down, thereby improving the leveling efficiency.

### BRIEF DESCRIPTION OF THE DRAWINGS

In order to more clearly illustrate the embodiments of the present application or the technical solutions in the related art, the following briefly introduces the drawings required for use in the embodiments or the description of the related art. Obviously, the drawings described below are only some embodiments of the present application. For those skilled in the art, other drawings can be obtained based on the structures shown in these drawings without paying any creative efforts.

FIG. 1 is a schematic structural diagram of a hot bed according to an embodiment of the present application.

FIG. 2 is a partial enlarged view of point A in FIG. 1.

FIG. 3 is a schematic exploded structure diagram of a hot bed according to an embodiment of the present application.

FIG. 4 is a schematic structural diagram of a connecting member according to an embodiment of the present application.

FIG. 5 is a schematic exploded structure diagram of a hot bed according to another embodiment of the present application.

FIG. 6 is a partial enlarged view of point B in FIG. 5.

FIG. 7 is a schematic exploded structure diagram of a hot bed according to another embodiment of the present application from another perspective.

FIG. 8 is a partial enlarged view of point C in FIG. 7.

The purpose, features and advantages of the present application will be further explained in conjunction with embodiments and with reference to the accompanying drawings.

### DETAILED DESCRIPTION OF THE EMBODIMENTS

The following will be combined with the drawings in the embodiments of the present application to clearly and completely describe the technical solutions in the embodiments of the present application. Obviously, the embodiments described are only part of the embodiments of the present application, not all of the embodiments. Based on the embodiments of the present application, all other embodiments obtained by those skilled in the art without making creative efforts shall fall within the scope of protection of the present application.

It should be noted that if the embodiments of the present application involve directional indications (such as up, down, left, right, front, back, etc.), such directional indications are only used to explain the relative position relationship, movement status, etc. between the various components in a certain specific posture. If the specific posture changes, the directional indication will also change accordingly.

In addition, if there are descriptions involving “first”, “second”, etc. in the embodiments of the present application, the descriptions of “first”, “second”, etc. are only for descriptive purposes and cannot be understood as indicating or implying their relative importance or implicitly indicating the number of the indicated technical features. Therefore, the features limited to “first” and “second” may explicitly or implicitly include at least one of such features. In addition, if “and/or” appears in the full text, its meaning includes three parallel schemes. Taking “A and/or B” as an example, it includes scheme A, or scheme B, or a scheme in which A and B are satisfied at the same time. In addition, the technical solutions between the various embodiments can be combined with each other, but it must be based on the ability of those skilled in the art to implement. When the combination of technical solutions is mutually contradictory or cannot be implemented, it should be deemed that such a combination of technical solutions does not exist and is not within the scope of protection required by the present application.

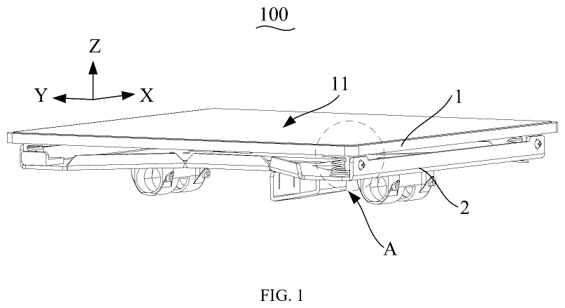

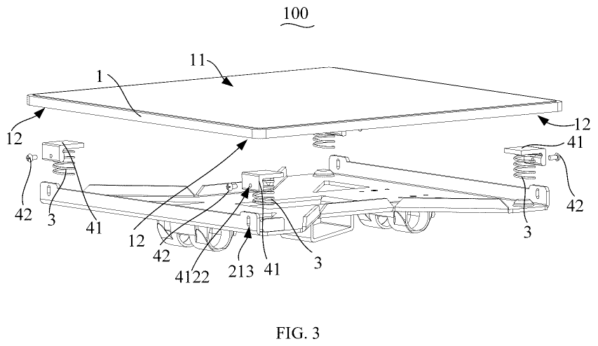

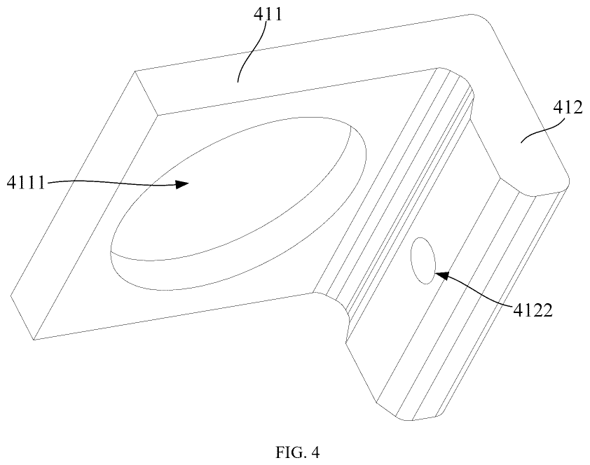

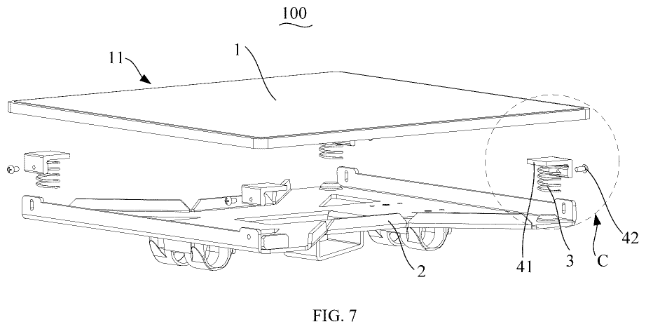

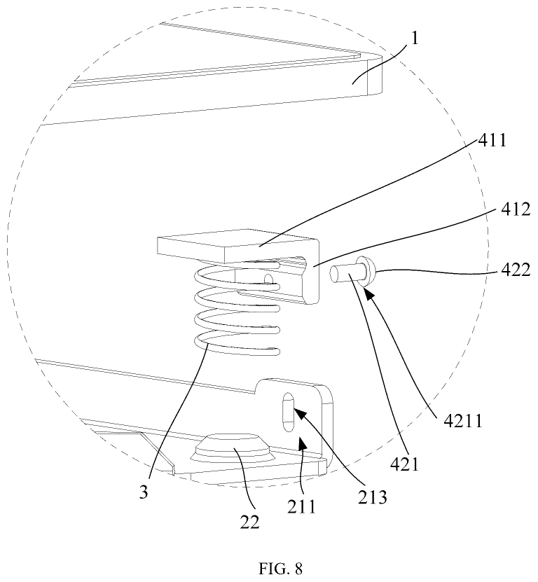

As shown in FIG. 1 to FIG. 8, the present application provides a hot bed 100 including a printing platform 1, a support frame 2, and a locking assembly 4. The printing platform 1 has a printing surface 11 for supporting a printed object. The support frame 2 is disposed on the side of the printing platform 1 opposite the printing surface 11. The support frame 2 and the printing platform 1 are spaced apart along a first direction and elastically connected by an elastic member 3. The first direction is perpendicular to the printing surface 11. The locking assembly 4 is provided at the printing platform 1 and is provided with a friction surface 43 that abuts the support frame 2. The friction surface 43 is parallel to the first direction. A friction force parallel to the first direction is generated between the friction surface 43 and the support frame 2. The friction force is used to restrict relative movement of the printing platform 1 and the support frame 2 in the first direction. The elastic member 3 may be a spring, and the first direction may be the thickness direction of the hot bed, i.e., the Z-axis direction in FIG. 1.

In this embodiment, the printing surface 11 is used to support the printed object and provide a placement base for the printed object. The printing platform 1 can also heat the printed object to prevent the printed object from warping due to thermal expansion and contraction during printing, which affects the printing quality. The support frame 2 is used to support the printing platform 1 and is installed on the side of the printing platform 1 opposite the printing surface 11. It can be understood that during leveling, the position of the printing surface 11 relative to the nozzle is leveled so that the distance between the printing surface 11 and the nozzle in the first direction is consistent, and the first direction is perpendicular to the printing surface 11. Therefore, the printing platform 1 and the support frame 2 are spaced apart along the first direction and elastically connected by the elastic member 3, so that the support frame 2 and the printing platform 1 have the freedom to move relative to each other in the first direction. The leveling of the printing surface 11 can be achieved by changing the relative distance between the printing platform 1 and the support frame 2 at each position in the first direction. Locking assembly 4 is provided at printing platform 1 and is provided with a friction surface 43 that abuts support frame 2. After leveling is completed, the friction force between friction surface 43 and support frame 2 restricts the relative movement of printing surface 11 and support frame 2, thereby preventing the printing platform 1 and support frame 2 from moving relative to each other after leveling is completed. In this embodiment, the printing platform 1 and support frame 2 are fixed only by locking assembly 4, simplifying the connection structure between the two. During leveling, the printing surface 11 can be directly pressed downward, thereby improving leveling efficiency.

As will be appreciated, the elastic member 3 supports the printing platform 1. Under the gravity of the printing platform 1, the elastic member 3 is deformed by the pressure of the printing platform 1. The maximum static friction force between the friction surface 43 and the support frame 2 is adjustable. Before leveling, the maximum static friction force can be reduced or even set to zero to facilitate relative movement of the printing platform 1 and the support frame 2 in the first direction.

In actual implementation, the printing surface 11 can be equivalent to the upper surface of the printing platform 1, and the support frame 2 is located below the printing platform 1. During leveling, the nozzle selects a point on the printing surface 11 as a reference point, confirms the distance between the nozzle and the reference point in the first direction, and then the nozzle sequentially presses down at least two other points on the printing surface 11 to a position flush with the reference point, so that the distance between the nozzle and the two points in the first direction is consistent with the distance between the nozzle and the reference point in the first direction, thus completing the leveling of the printing surface 11. The reference point and the at least two pressing points are not collinearly arranged. After leveling is completed, the maximum static friction force between the friction surface 43 and the support frame 2 can be increased to enable the locking assembly 4 to lock the printing platform 1 and the support frame 2, thereby ensuring that the printing surface 11 always remains in a leveled state during the printing process, thereby ensuring printing quality. Since the printing platform 1 needs to overcome the maximum static friction force and the elastic force of the elastic member 3 to move downward when the nozzle presses down the printing platform 1, reducing the maximum static friction force between the friction surface 43 and the support frame 2 before leveling can reduce the resistance of the printing platform 1 to move downward, so as to avoid excessive force between the nozzle and the printing platform 1 causing damage to the nozzle or the printing platform 1.

In an embodiment, before leveling, the maximum static friction force between friction surface 43 and support frame 2 can be adjusted to be no less than the difference between the elastic force of elastic member 3 and the gravity of printing platform 1. In the absence of external forces, the friction force is static friction force, and printing platform 1 remains in a static equilibrium state under the influence of gravity, the elastic force of elastic member 3, and the friction force of the support frame 2 on friction surface 43. In this way, when the nozzle is not pressing down on printing surface 11, printing platform 1 remains stationary, assisting leveling and reducing the possibility of relative movement between printing platform 1 and support frame 2 during leveling, thereby preventing any impact on leveling accuracy.

In practice, the locking assembly 4 abuts the support frame 2 via the friction surface 43, thereby also restricting relative movement between the support frame 2 and the printing platform 1 in a second direction. The second direction is perpendicular to the first direction. The first direction is the Z-axis, and the second direction can be the X-axis, the Y-axis, or another direction perpendicular to the Z-axis. The side of the support frame 2 facing away from the printing platform 1 is also provided with a mounting structure for connecting the drive member, which is not specifically defined herein.

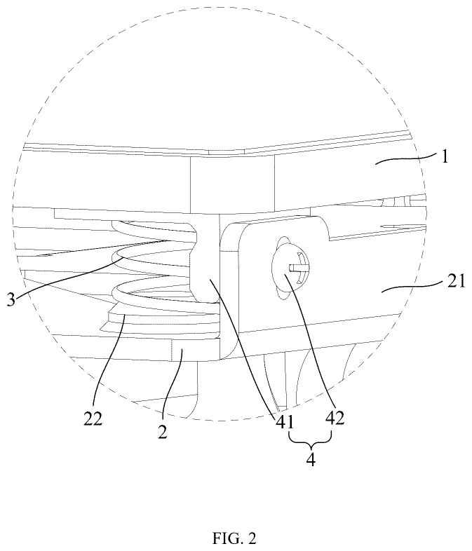

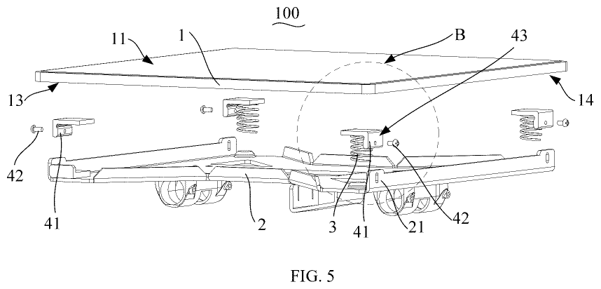

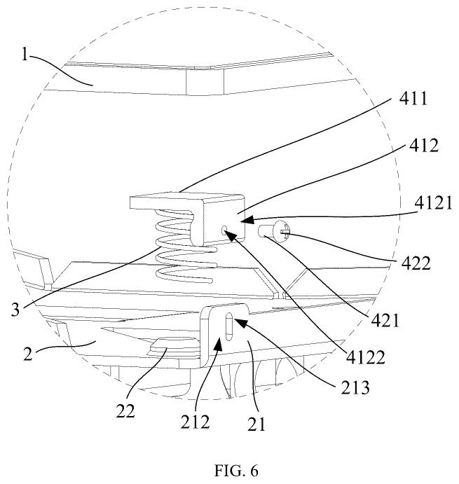

In an embodiment of the present application, as shown in FIG. 1, FIG. 2, FIG. 5, and FIG. 6, the locking assembly 4 includes a connecting member 41 and a fastening member 42. The connecting member 41 is disposed on the printing platform 1. The connecting member 41 is provided with a first surface 4121 that abuts against the support frame 2. The first surface 4121 serves as a friction surface 43. The fastening member 42 is used to adjust the relative position of the first surface 4121 and the support frame 2 in a first direction. The fastening member 42 may be a cross screw, a slotted screw, or a torx screw.

In this embodiment, the first surface 4121 of the connecting member 41 serves as a friction surface 43 and abuts against the support frame 2, and a friction force along a first direction can be generated between the first surface 4121 and the support frame 2. The fastening member 42 is used to fix the connecting member 41 and the support frame 2, and can close the connecting member 41 and the support frame 2 so that the connecting member 41 and the support frame 2 are pressed against each other, and a positive pressure is generated between the first surface 4121 and the support frame 2, thereby generating a friction force between the first surface 4121 and the support frame 2. By adjusting the tightness of the fastening member 42, the positive pressure generated between the first surface 4121 and the support frame 2 can be changed, thereby adjusting the maximum static friction force between the first surface 4121 and the support frame 2, so as to adjust the relative position of the first surface 4121 and the support frame 2 in the first direction during leveling.

In actual implementation, as shown in FIG. 5 to FIG. 8, the first surface 4121 is arranged parallel to the first direction, and the support frame 2 includes an extension portion 21 parallel to the first direction. The extension portion 21 is provided with a first abutting surface 211 abutting against the first surface 4121. and the fastening member 42 can relatively squeeze the connecting member 41 and the extension portion 21 so that the first surface 4121 and the first abutting surface 211 press against each other to generate positive pressure, thereby enabling a friction force parallel to the first direction to be generated between the first surface 4121 and the first abutting surface 211. The fastening member 42 can be a clamp with adjustable tightness, which realizes the mutual pressure between the first surface 4121 and the first abutting surface 211 by relatively clamping the connecting member 41 and the extension portion 21. The tighter the clamp is clamped, the greater the positive pressure between the first surface 4121 and the first abutting surface 211, and the greater the maximum static friction force between the first surface 4121 and the first abutting surface 211. The looser the clamp is clamped, the smaller the positive pressure between the first surface 4121 and the first abutting surface 211, and the smaller the maximum static friction force between the first surface 4121 and the first abutting surface 211. In this way, the maximum static friction force between the friction surface 43 of the locking assembly 4 and the support frame 2 is adjusted.

In an embodiment of the present application, as shown in FIG. 5 to FIG. 8, the connecting member 41 is provided with a connecting hole 4122, the fastening member 42 includes a connecting portion 421 and an abutting portion 422, and the abutting portion 422 is connected to one end of the connecting portion 421. The support frame 2 is provided with a sliding hole 213, the other end of the connecting portion 421 is passed through the sliding hole 213 and is connected to the connecting hole 4122. The abutting portion 422 is provided with a second surface 4221, the second surface 4221 abuts against the support frame 2, and the second surface 4221 is also the friction surface 43.

In this embodiment, the abutting portion 422 and the connecting member 41 are located on different sides of the support frame 2. The abutting portion 422 is connected to one end of the connecting portion 421, and the other end of the connecting portion 421 passes through the sliding hole 213 of the support frame 2 and connects to the connecting hole 4122 of the connecting member 41. Simultaneously, the first surface 4121 of the connecting member 41 and the second surface 4221 of the abutting portion 422 press against the support frame 2 from different sides. Both the first surface 4121 and the second surface 4221 act as friction surfaces 43. By adjusting the tightness of the connection between the connecting portion 421 and the connecting member 41, the positive pressure between the connecting member 41 and the support frame 2 and between the abutting portion 422 and the support frame 2 can be changed, thereby adjusting the maximum static friction force between the friction surface 43 and the support frame 2. Simultaneously, the connecting portion 421 is adapted to slide in the sliding hole 213. The sliding hole 213 plays a role in avoiding the connecting portion 421 when the printing platform 1 and the support frame 2 slide relative to each other, thereby preventing the fastening member 42 from obstructing the relative sliding of the printing platform 1 and the support frame 2.

In actual implementation, the support frame 2 is provided with an extension portion 21 parallel to the first direction, and the sliding hole 213 is provided in the extension portion 21. At the same time, the extension portion 21 is provided with a first abutting surface 211 and a second abutting surface 212 that are separated from each other, respectively abutting the first surface 4121 and the second surface 4221. In an embodiment, the connecting hole 4122 and the connecting portion 421 can be connected by threaded engagement. By tightening or loosening the fastening member 42, the positive pressure between the connecting member 41 and the support frame 2 and the abutting portion 422 and the support frame 2 can be increased or decreased, thereby increasing or decreasing the maximum static friction force between the friction surface 43 and the support frame 2. In an embodiment, the connecting hole 4122 can also be provided as a through hole, and the connecting portion 421 passes through the connecting hole 4122 and is threadedly connected by a nut. In this way, the fastening member 42 can also connect the connecting member 41 and the support frame 2. In an embodiment, the fastening member 42 can be a bolt or a screw, the connecting portion 421 is a screw, and the abutting portion 422 is a nut. The connection direction of the connecting portion 421 may be set along the second direction.

It can be understood that the first surface 4121 and the first abutting surface 211, and the second surface 4221 and the second abutting surface 212 are arranged parallel to each other and are all arranged parallel to the first direction. In this way, in addition to being able to generate a friction force parallel to the first direction with the support frame 2, the friction surface 43 does not structurally hinder the printing platform 1 and the support frame 2 from sliding relative to each other in the first direction. At the same time, the first surface 4121 and the first abutting surface 211, and the second surface 4221 and the second abutting surface 212 can limit the printing platform 1 and the support frame 2 in the second direction. The second direction is perpendicular to the first direction. The first direction is the Z-axis direction, and the second direction can be the X-axis direction, the Y-axis direction, and other directions perpendicular to the Z-axis direction. The second directions in which the first surface 4121 and the first abutting surface 211, and the second surface 4221 and the second abutting surface 212 limit each other can be the same or different. If the second direction in which the first surface 4121 and the first abutting surface 211 are mutually limited is the X-axis direction, then the second direction in which the second surface 4221 and the second abutting surface 212 are mutually limited is another direction that is at an angle of 30° or 45° to the X-axis direction. The two second directions are not perpendicular to each other, and the connection direction of the fastening member 42 is parallel to the second direction in which the second surface 4221 and the second abutting surface 212 are mutually limited. This allows the printing platform 1 and the support frame 2 to be limited in the X-axis and Y-axis directions, preventing relative displacement between the printing platform 1 and the support frame 2 in directions other than the first direction. The X-axis, Y-axis, and Z-axis are shown in FIG. 1.

In an embodiment of the present application, as shown in FIG. 5 to FIG. 8, the connecting member 41 includes a first part 411 and a second part 412 connected at an angle, the first part 411 is connected to a side of the printing platform 1 opposite the printing surface 11, and the second part 412 is arranged parallel to the first direction and is provided with a first surface 4121 and a connecting hole 4122.

In this embodiment, the first part 411 is connected to the printing platform 1 to increase the connection area between the connecting member 41 and the printing platform 1, thereby improving the stability of the connection between the connecting member 41 and the printing platform 1. The second part 412 is provided with a first surface 4121 that abuts the support frame 2 and a connecting hole 4122 for connecting the connecting portion 421, which is used to connect to the fastening member 42. The second part 412 is arranged parallel to the first direction to form a first surface 4121 parallel to the first direction. The first surface 4121 abuts the support frame 2 and is also suitable for relative movement with the support frame 2 along the first direction.

In actual implementation, the connecting member 41 can be configured in an L-shape, with the first part 411 and the second part 412 arranged perpendicularly. The second part 412 is located on the inner side of the extension portion 21. The first part 411 is provided at the side of the printing platform 1 opposite the printing surface 11 to facilitate alignment with the printing platform 1 and improve the stability of the connection between the connecting member 41 and the printing platform 1. In an embodiment, the first part 411 and the printing platform 1 can be connected by a detachable connection method such as screws or bolts. The first part 411 and the printing platform 1 can also be integrally formed.

In an embodiment of the present application, as shown in FIG. 1 to FIG. 4, the first part 411 is provided with a limiting slot 4111, the support frame 2 is provided with a limiting protrusion 22, one end of the elastic member 3 is limited to the limiting slot 4111, and the other end of the elastic member 3 is sleeved on the limiting protrusion 22.

In this embodiment, one end of the elastic member 3 is connected to the support frame 2 by being sleeved on the limiting protrusion 22, and the other end of the elastic member 3 is limited in the limiting slot 4111 to achieve connection with the first part 411, and indirectly achieve connection with the printing platform 1. It is understandable that the elastic member 3 can be a spring, and one end of the elastic member 3 is located in the limiting slot 4111 and is limitedly abutted against the slot wall of the limiting slot 4111, so that the elastic member 3 cannot move within the limiting slot 4111. The other end of the elastic member 3 is sleeved on the limiting protrusion 22 and is limitedly abutted against the side wall of the limiting protrusion 22, so that the elastic member 3 cannot move relative to the limiting protrusion 22, thereby ensuring the stability of the setting position of the elastic member 3.

In actual implementation, the first part 411 may be provided with a limiting protrusion 22 and the support frame 2 may be provided with a limiting slot 4111, or the first part 411 may be provided with a limiting protrusion 22 and the support frame 2 may also be provided with a limiting protrusion 22, or the first part 411 may be provided with a limiting slot 4111 and the support frame 2 may also be provided with a limiting slot 4111, and no specific limitation is made here.

In an embodiment of the present application, as shown in FIG. 5 to FIG. 8, the sliding hole 213 extends along the first direction, the diameter of the connecting portion 421 is consistent with the width of the sliding hole 213, and the direction of the width is perpendicular to the first direction; and/or, the diameter of the connecting portion 421 is consistent with the aperture of the connecting hole 4122.

In this embodiment, the sliding hole 213 extends along a first direction. When the printing platform 1 and the support frame 2 slide relative to each other in the first direction, the connecting portion 421 also moves along the sliding hole 213 relative to the support frame 2. The diameter of the connecting portion 421 is consistent with the width of the sliding hole 213. This allows the connecting portion 421 and the sliding hole 213 to abut and limit in a third direction. The third direction is perpendicular to the first direction, and is also perpendicular to the second direction in which the second abutting surface 212 and the second surface 4221 are limitedly abutted against each other. This allows the printing platform 1 and the support frame 2 to be fixedly connected in directions other than the first direction. The diameter of the connecting portion 421 is consistent with the aperture of the connecting hole 4122. Therefore, when the connecting portion 421 is connected to the connecting hole 4122, the relative position of the connecting portion 421 and the connecting hole 4122 remains unchanged, and the fastening member 42 moves with the printing platform 1.

In actual implementation, the sliding hole 213 can also be provided on the connecting member 41, and the connecting hole 4122 is provided on the extension portion 21 of the support frame 2. The connecting portion 421 of the fastening member 42 is passed through the sliding hole 213 and installed in the connecting hole 4122. The abutting portion 422 and the extension portion 21 press the connecting member 41 from both sides of the connecting member 41. When leveling the printing platform 1, the printing platform 1 moves along the first direction relative to the support frame 2 and the fastening member 42 at the same time.

In an embodiment of the present application, as shown in FIG. 5 to FIG. 8, there are a plurality of locking assemblies 4 and a plurality of elastic members 3, each elastic member 3 is arranged adjacent to one locking assembly 4, and the elastic force direction of the elastic member 3 is arranged parallel to the first direction.

In this embodiment, the locking assembly 4 and the elastic member 3 are arranged in a one-to-one correspondence. Thus, during leveling, the nozzle can press down on the printing surface 11 in accordance with the positions of the locking assembly 4 and the elastic member 3. In other words, the downward pressing position of the nozzle overlaps with the projection of the elastic member 3 perpendicular to the first direction, thereby improving the stability of the movement of the printing platform 1 when pressed by the nozzle. Furthermore, the elastic force of the elastic member 3 is along the first direction, ensuring that when the printing platform 1 and the support frame 2 move relative to each other in the first direction, the elastic member 3 deforms along the first direction, thereby improving the stability of the elastic member 3 supporting the printing platform 1.

As will be appreciated, the spacing between the printing platform 1 and the support frame 2 along the first direction is relatively small compared to the overall size of the hot bed 100. In this embodiment, the elastic member 3 and the locking assembly 4 are also relatively small. During leveling, the multiple pressing positions of the nozzle are typically spaced far apart to ensure leveling of the entire printing surface 11. When the nozzle presses downwardly along the first direction at a specific pressing position of the printing platform 1, the printing platform 1 practically does not move at other pressing positions. Therefore, a locking assembly 4 is provided at each pressing position of the printing platform 1, allowing for independent control of the movement of the printing platform 1 at each pressing position. Before leveling, the locking assembly 4 corresponding to each pressing position can reduce or adjust to zero the maximum static friction force between the friction surface 43 and the support frame 2. After that, the nozzle presses down the printing platform 1 at the pressing position in turn. After the printing platform 1 at a pressing position is pressed into place, the maximum static friction force between the friction surface 43 of the locking assembly 4 and the support frame 2 corresponding to the pressing position is increased. In this way, the printing platform 1 and the support frame 2 corresponding to each pressing position are leveled and locked in turn, which can improve the accuracy of leveling. An elastic member 3 can also be correspondingly provided near each locking assembly 4 to ensure the stability of the printing platform 1 corresponding to each pressing position in moving along the first direction when the nozzle presses down the printing platform 1 at the pressing position in turn. In an embodiment, the elastic member 3 and the pressing position can also be provided in a one-to-many manner.

In actual implementation, a plurality of elastic members 3 are arranged between the printing platform 1 and the support frame 2, which can ensure the stability when carrying the printing platform 1. The printing platform 1 is provided with a plurality of locking assemblies 4, which can ensure the reliability and stability when the printing platform 1 and the support frame 2 are locked.

In actual implementation, the elastic member 3 is arranged between the first part 411 of the connecting member 41 and the support frame 2, so that in the projection perpendicular to the first direction, the pressing position can be arranged to overlap with the connecting member 41 and the elastic member 3. In this way, when the nozzle presses down the printing platform 1 at the pressing position, the elastic member 3 and the locking assembly 4 are actually pressed down together, thereby improving the smoothness of the movement of the printing platform 1 at the pressing position.

In an embodiment of the present application, as shown in FIG. 1 to FIG. 3, the projection of the printing platform 1 perpendicular to the first direction is arranged in a quadrilateral and has four corners 12. The locking assemblies 4 include four, and each locking assembly 4 is arranged corresponding to a corner 12.

In this embodiment, the pressing positions of the printing platform 1 are actually the four corners 12 of the printing platform 1, ensuring the accuracy and reliability of the leveling of the printing surface 11. Accordingly, a locking assembly 4 is installed at each of the four corners 12 of the printing platform 1. During leveling, after each corner 12 is pressed down into position, the locking assembly 4 can be used to lock the corner 12, thereby sequentially leveling and locking all four corners 12. The elastic members 3 can also be provided in a one-to-one correspondence with the corners 12.

It is understandable that before leveling, the maximum static friction force between the friction surface 43 of each locking assembly 4 and the support frame 2 can be adjusted to zero to allow the printing platform 1 to be naturally placed on the elastic member 3. After that, the maximum static friction force between the friction surface 43 and the support frame 2 can then be slightly increased so that it is always no less than the difference between the elastic force of the elastic member 3 and the gravity of the printing platform 1 to assist in leveling. During leveling, it is necessary to select a reference point on the printing surface 11. The reference point is one of the four corners 12. The nozzle can first press down on one corner 12 and use the pressed corner 12 as the reference point to ensure that the reference point is the lowest point among the four corners 12. The nozzle then presses down on at least two other corners 12 for leveling, thereby completing the leveling of the printing platform 1 relative to the nozzle.

In actual implementation, an elastic member 3 is further provided between each corner 12 and the support frame 2. The projection of the printing platform 1 perpendicular to the first direction can be a rectangle, square, trapezoid, or other regular shape such as a triangle, pentagon, or hexagon. The locking assembly 4 and the elastic member 3 are provided in a one-to-one correspondence with the corners 12.

In an embodiment of the present application, as shown in FIG. 1, FIG. 2, FIG. 5 to FIG. 8, the printing platform 1 is provided with a fixed position 13 and at least two mounting positions 14. The printing platform 1 is rotatably connected to the support frame 2 at the fixed position 13, and the printing platform 1 is provided with a locking assembly 4 at each mounting position 14.

In this embodiment, the printing platform 1 is rotatably connected to the support frame 2 at a fixed position 13. That is, the relative distance between the printing platform 1 and the support frame 2 in the first direction at the fixed position 13 remains unchanged, but the printing platform 1 is adapted to tilt relative to the fixed position 13. The printing platform 1 is also provided with at least two mounting positions 14, each of which is provided with a corresponding locking assembly 4. Thus, the printing platform 1 and the support frame 2 can slide along the first direction at the mounting positions 14. It is understood that each mounting position 14 may also be provided with an elastic member 3, and the printing platform 1 is connected to the support frame 2 at the mounting position 14 via the elastic member 3. Before leveling, the friction force between the friction surface 43 of the locking assembly 4 and the support frame 2 is adjusted to zero, and the printing platform 1 is naturally placed on the elastic member 3. The height of the printing platform 1 at the fixed position 13 is set no higher than the current height of the printing platform 1 at the mounting position 14. The position of the printing surface 11 at the fixed position 13 is then selected as a reference point, and at least two mounting positions 14 are pressed down for leveling.

In actual implementation, the printing platform 1 can be provided with a connecting member 41 and a fastening member 42 at the fixed position 13. The connecting member 41 is provided with a connecting hole 4122, and the support frame 2 is provided with a through hole corresponding to the connecting hole 4122. The fastening member 42 passes through the through hole and is connected to the connecting hole 4122. The aperture of the through hole is consistent with the diameter of the connecting portion 421 of the fastening member 42, so as to relatively limit the printing platform 1 and the support frame 2 in any direction, but the printing platform 1 can rotate around the fastening member 42 relative to the support frame 2.

The present application also provides a 3D printer including a print head mechanism and a hot bed 100. The specific structure of the hot bed 100 is shown in the above-described embodiments. Since the present 3D printer utilizes all of the technical solutions of all of the above-described embodiments, it possesses at least all of the beneficial effects provided by the technical solutions of the above-described embodiments, and therefore, no further description is given here. The print head mechanism can level the printing platform 1 of the hot bed 100. The specific leveling process is as described above. After leveling is completed, the printing platform 1 and the support frame 2 are locked by a locking assembly 4, thereby fixing the relative positions.

The above description is merely an exemplary embodiment of the present application and does not limit the patent scope of the present application. All equivalent structural transformations made using the contents of the present application specification and drawings under the technical concept of the present application, or direct/indirect application in other related technical fields are included in the patent protection scope of the present application.

What is claimed is:

1. A hot bed, comprising:
a printing platform provided with a printing surface for supporting a printed object;
a support frame provided at a side of the printing platform opposite the printing surface, wherein the support frame is spaced apart from the printing platform along a first direction and elastically connected to the printing platform by an elastic member, and the first direction is perpendicular to the printing surface; and
a locking assembly provided at the printing platform, wherein the locking assembly is provided with a friction surface abutting the support frame, and the friction surface is parallel to the first direction; and there is a friction force parallel to the first direction between the friction surface and the support frame, and the friction force is configured to restrict relative movement between the printing platform and the support frame in the first direction.

2. The hot bed according to claim 1, wherein the locking assembly comprises a connecting member and a fastening member, and the connecting member is provided at the printing platform;
and the connecting member is provided with a first surface abutting the support frame, the first surface is the friction surface, and the fastening member is configured to adjust a relative position between the first surface and the support frame in the first direction.

3. The hot bed according to claim 2, wherein:
the connecting member is provided with a connecting hole, and the fastening member comprises a connecting portion and an abutting portion;
the abutting portion is connected to one end of the connecting portion, the support frame is provided with a sliding hole, and another end of the connecting portion is passed through the sliding hole and is connected to the connecting hole; and
the abutting portion is provided with a second surface abutting the support frame, and the second surface is also the friction surface.

4. The hot bed according to claim 3, wherein the connecting member comprises a first part and a second part connected at an angle, the first part is connected to a surface of the printing platform opposite the printing surface, and the second part is parallel to the first direction and is provided with the first surface and the connecting hole.

5. The hot bed according to claim 4, wherein the first part is provided with a limiting slot, the support frame is provided with a limiting protrusion, one end of the elastic member is limited within the limiting slot, and another end of the elastic member is sleeved on the limiting protrusion.

6. The hot bed according to claim 3, wherein the sliding hole is configured to extend along the first direction, a diameter of the connecting portion is consistent with a width of the sliding hole, and a direction of the width of the sliding hole is perpendicular to the first direction.

7. The hot bed according to claim 3, wherein a diameter of the connecting portion is consistent with an aperture of the connecting hole.

8. The hot bed according to claim 1, wherein the locking assembly comprises a plurality of locking assemblies, the elastic member comprises a plurality of elastic members, each elastic member is provided adjacent to one locking assembly, and an elastic force direction of each elastic member is parallel to the first direction.

9. The hot bed according to claim 1, wherein a projection of the printing platform perpendicular to the first direction is quadrilateral and has four corners, the locking assembly comprises four locking assemblies, and each locking assembly is provided corresponding to one corner.

10. The hot bed according to claim 1, wherein the printing platform is provided with a fixed position and at least two mounting positions, the printing platform is rotatably connected to the support frame at the fixed position, and the printing platform is provided with one locking assembly at each mounting position.

11. A three dimensional (3D) printer, comprising:
a print head mechanism; and
the hot bed according to claim 1, wherein the print head mechanism is adapted to press the printing platform to level the printing surface.
